(19) United States
(12) Patent Application Publication
(10) Pub. No.: US 2016/0307594 A1
(43) Pub. Date: Oct. 20, 2016

(54) MAGNETIC DISK DEVICE AND METHOD OF CONTROLLING MAGNETIC DISK

(71) Applicant: Kabushiki Kaisha Toshiba, Tokyo (JP)

(72) Inventor: Ryuichi Sato, Kawasaki Kanagawa (JP)

(21) Appl. No.: 14/823,098

(22) Filed: Aug. 11, 2015

Related U.S. Application Data
(60) Provisional application No. 62/148,276, filed on Apr. 16, 2015.

(51) Int. Cl. G11B 20/10; G11B 5/596

(52) U.S. Cl. CPC G11B 20/10212; G11B 5/59627

(57) ABSTRACT

According to one embodiment, a controller of a magnetic disk device is configured to manage a first value representing the number of times of writing for each track on a magnetic disk. The controller detects a first off-track amount during writing for a first track that is a writing target track, calculates a second value exponentially increasing according to the detected first off-track amount, and adds the calculated second value to the first values of tracks adjacent to both sides of the first track.

### CROSS-REFERENCE TO RELATED APPLICATIONS

This application is based upon and claims the benefit of priority from U.S. Provisional Application No. 62/148,276, filed on Apr. 16, 2015; the entire contents of which are incorporated herein by reference.

### FIELD

Embodiments described herein relate generally to a magnetic disk device and a method of controlling a magnetic disk.

### BACKGROUND

In magnetic disk devices, in order to protect data from side erasing, an adjacent track interference (ATI) countermeasure is executed. In such an ATI countermeasure, a plurality of tracks arranged inside a magnetic disk are divided into a plurality of track groups, and a plurality of tracks are configured to belong to one track group. The number of times of writing for a plurality of tracks belonging to each track group are counted, and, in response to the counted value exceeding a threshold, a refresh operation for the plurality of tracks belonging to the track group is executed. In the refresh operation, data is read from each track of a target track group, and the read data is written into the track.

### BRIEF DESCRIPTION OF THE DRAWINGS

FIG. 1 is a functional block diagram that illustrates an internal configuration of a magnetic disk device;

FIG. 2 is a block diagram that illustrates an example of a functional configuration of a controller;

FIG. 3 is a diagram that illustrates an example of an ATI management table;

FIG. 4 is a flowchart that illustrates an operation sequence of a part of an ATI process;

FIG. 5 is a diagram that illustrates an example of side erasing;

FIG. 6 is a flowchart that illustrates an operation sequence of the other part of the ATI process;

FIG. 7 is a flowchart that illustrates a process sequence for acquiring a weighting coefficient;

FIG. 8 is a graph that illustrates a measurement result of relation between a Viterbi margin and the number of times of writing; and

FIG. 9 is a graph that illustrates relation between a weighting coefficient and the weighted number of times of writing.

### DETAILED DESCRIPTION

In general, according to one embodiment, a magnetic disk device includes: a magnetic head; a magnetic disk; and a controller. The magnetic disk corresponds to the magnetic head. The controller manages a first value representing the number of times of writing for each track on the magnetic disk, executes a refresh process for a track having the first value exceeding a first threshold. The refresh process includes reading data from the track and rewriting the read data into the track. The controller detects a first off-track amount during writing for a first track being a writing target track. The controller calculates a second value exponentially increasing according to the detected first off-track amount and adds the calculated second value to the first values of tracks adjacent to both sides of the first track.

Exemplary embodiments of a magnetic disk device and a method of controlling a magnetic disk will be explained below in detail with reference to the accompanying drawings. The present invention is not limited to the following embodiments.

### Embodiment

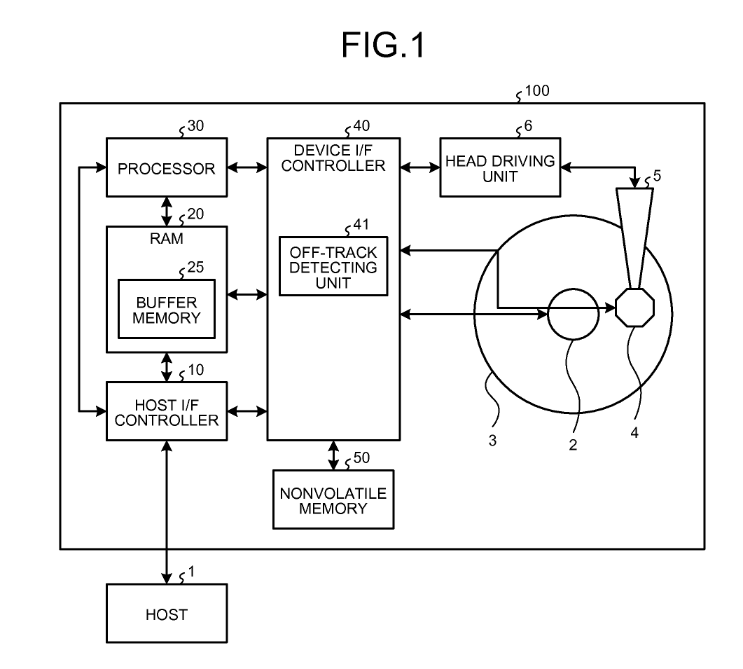

FIG. 1 illustrates an example of the configuration of a magnetic disk device 100 according to an embodiment. The magnetic disk device 100 known as a hard disk drive (HDD) is connected to a host apparatus (hereinafter, abbreviated as a host) 1 and functions as an external storage device of the host 1.

The magnetic disk device 100 includes a magnetic disk 3 that is a recording medium rotated by a spindle motor 2. The magnetic disk device 100 includes a head actuator 5 that is driven by a head driving unit 6. At a tip end of the head actuator 5, a magnetic head 4 used for writing and reading data is mounted.

The magnetic disk device 100 includes: a host interface controller (host I/F controller) 10; a random access memory (RAM) 20; a processor 30; a device interface controller (device I/F controller) 40; and a nonvolatile memory 50 as a control system.

The host I/F controller 10 communicates with the host 1 for a command, data, a status report, and the like. When a command is received from the host 1, the host I/F controller 10 notifies the processor 30 of the command. Under the control of the processor 30, the host I/F controller 10 buffers data received from the host 1 in a buffer memory 25 or transmits data buffered in the buffer memory 25 to the host 1.

The RAM 20 has a storage area as the buffer memory 25 for temporarily storing data when write data supplied from the host 1 is written into the magnetic disk 3. In addition, the buffer memory 25 temporarily stores data when data read from the magnetic disk 3 is transmitted to the host 1. The RAM 20 further has a storage area for storing management information for managing data. In addition, firmware stored in the nonvolatile memory 50 is loaded into the RAM 20. The management information managed in the RAM 20 is backed up in the nonvolatile memory 50 or the magnetic disk 3. As the RAM 20, a static random access memory (SRAM) or a dynamic random access memory (DRAM) is used.

The nonvolatile memory 50 is configured by a flash memory, an EEPROM, or the like, and firmware executed by the processor 30 is stored therein. The firmware may be stored in the magnetic disk 3.

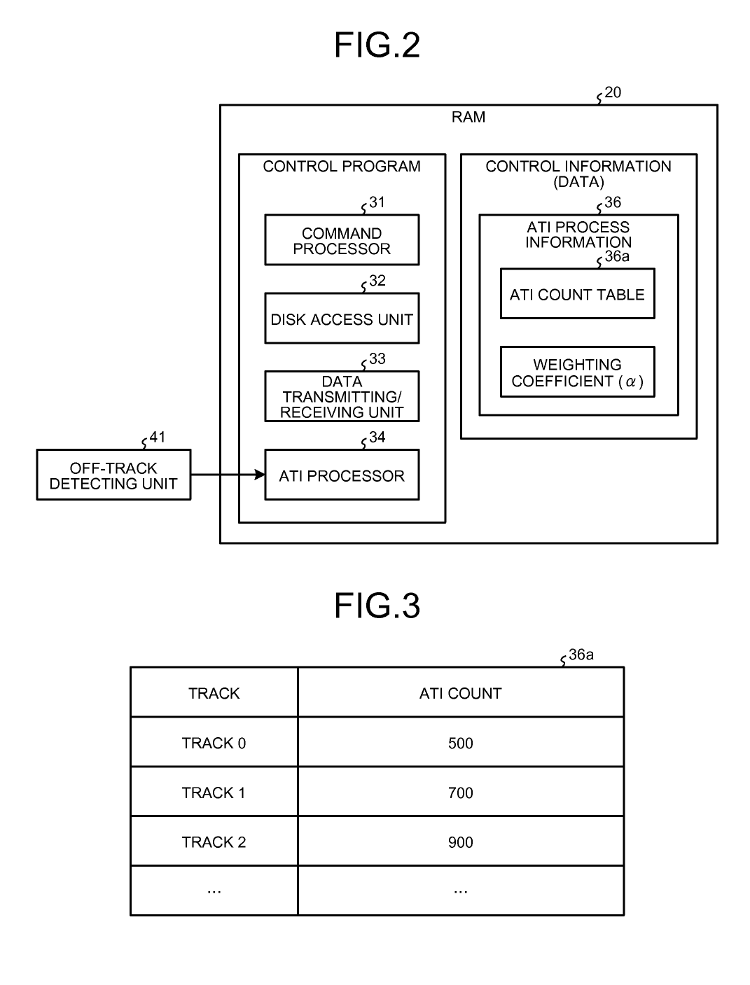

By controlling the driving of the spindle motor 2, the magnetic head 4, and the head driving unit 6, the device I/F controller 40 writes data into the magnetic disk 3 and reads data from the magnetic disk 3. The device I/F controller 40 includes an off-track detecting unit 41. When a write process for the magnetic disk 3 is performed, the off-track detecting unit 41 detects an off-track in which the magnetic head 4 deviates from a target position in the track width direction. The off-track detecting unit 41 notifies the ATI processor 34 (see FIG. 2) of a detected off-track amount OFT.

The processor 30 realizes various functions by using the firmware stored in the nonvolatile memory 50. When the magnetic disk device 100 starts to be operated, the firmware stored in the nonvolatile memory 50 is loaded into the RAM 20. The processor 30 executes the firmware loaded in the RAM 20. A function executed by the processor 30 will be described later.

When a write command and write data supplied from the host 1 are received by the host I/F controller 10, the processor 30 analyzes the content of the write command and stores the write data into the buffer memory 25. Thereafter, the write data is read from the buffer memory 25 and is input to the device I/F controller 40. The device I/F controller 40 codes the input write data and drives a writing element of the magnetic head 4, thereby writing the coded write data to the magnetic disk 3. When the coded write data is written, the device I/F controller 40 writes the data into a target track specified by the command with controlling the driving of the head driving unit 6 and the spindle motor 2.

On the other hand, when a read command supplied from the host 1 is received by the host I/F controller 10, the processor 30 analyzes the read command. Thereafter, the processor 30 instructs the device I/F controller 40 based on a result of the analysis. As a result, the magnetic head 4 is driven by the device I/F controller 40, and a signal is read by a reading element of the magnetic head 4. The read signal is demodulated by the device I/F controller 40 as read data. In addition, after being decoded, the read data is buffered into the buffer memory 25. Thereafter, the read data is transmitted to the host 1 by the host I/F controller 10.

FIG. 2 is a block diagram that illustrates an example of the functional configuration of firmware (control program) loaded into the RAM 20. The control program includes: a command processor 31; a disk access unit 32; a data transmitting/receiving unit 33; and an ATI processor 34 and functions as a controller of the magnetic disk device 100. The command processor 31 analyzes a command received from the host 1 and notifies the disk access unit 32 and the data transmitting/receiving unit 33 of a result of the analysis. By controlling the device I/F controller 40 based on the result of the analysis of the command, the disk access unit 32 drives the spindle motor 2, the magnetic head 4, and the head driving unit 6, thereby executing a read/write operation for the magnetic disk 3. The disk access unit 32 executes the process of updating the management information in accompaniment with a write operation for the magnetic disk 3. By controlling the host I/F controller 10 and the device I/F controller 40, the data transmitting/receiving unit 33 controls transmission of data between the magnetic disk 3 and the host 1 through the buffer memory 25.

The ATI processor 34 executes an ATI countermeasure process. As described above, in a comparative example, the number of times of writing for a plurality of tracks belonging to each track group is counted, and in response to the counted value exceeding a threshold, a refreshing operation for a plurality of tracks belonging to the track group is executed. However, according to such a method, in a case where approaching writing to an adjacent track occurs, an increase in the influence of erasing is not considered. In addition, in a case where the approaching writing to an adjacent track occurs, there is a possibility that the refresh operation is delayed. Furthermore, in a case where a threshold for the refresh operation is set to be small in consideration of the approaching writing to an adjacent track, while the refreshing timing is matched, the refresh operation is frequently executed, whereby the performance is degraded.

Thus, in this embodiment, the number of times of writing is managed for each track, and, in a case where approaching writing to an adjacent track occurs, the above-described number of times of writing of the adjacent track is updated based on a weighting factor according to the off-track amount. In addition, through an experiment performed by the present inventors, it is clarified that there is an exponentially adverse effect on the writing quality of an adjacent track in accordance with an increase in the off-track amount. For this reason, the weighting factor is set as a value that exponentially increases according to the off-track amount.

In the configuration illustrated in FIG. 2, the ATI processor 34 executes an ATI countermeasure process by using ATI process information 36. The ATI process information 36 includes an ATI count table 36a and a weighting coefficient α (fixed value).

FIG. 3 illustrates the ATI count table 36a. In the ATI count table 36a, the number C of times of writing is managed for each track. Hereinafter, the number C of times of writing that is managed for each track will be referred to as an ATI count value.

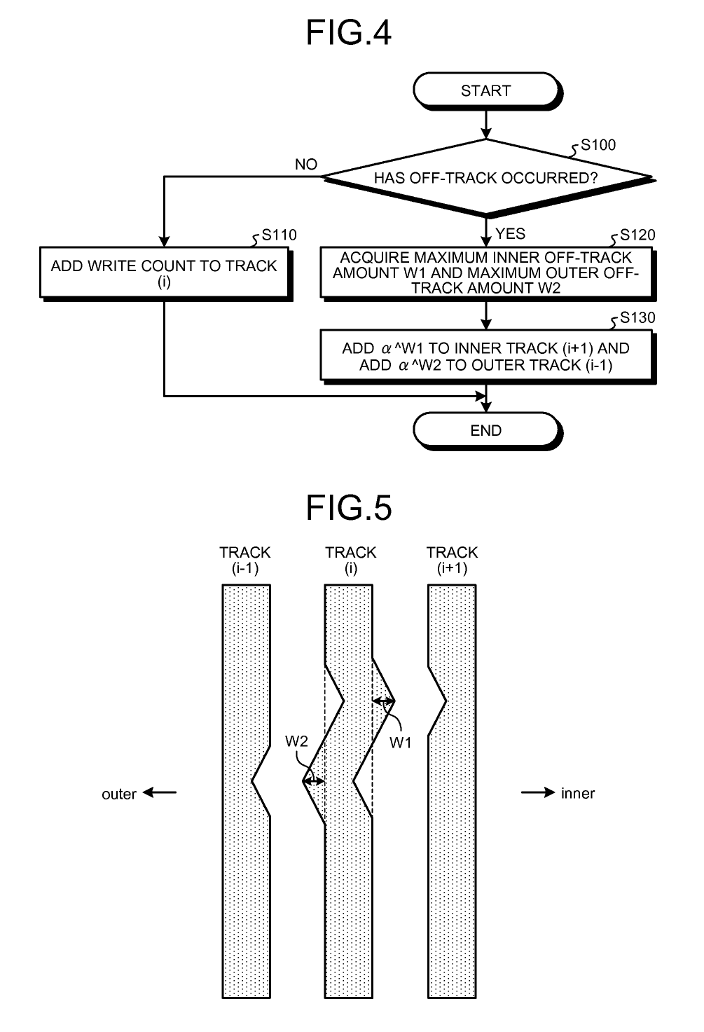

In a case where data writing to the magnetic disk 3 has occurred, the ATI processor 34 calculates the number of times of writing (a write count) in units of tracks. Next, the ATI processor 34 executes a process illustrated in FIG. 4 for one or a plurality of tracks into which data has been written. FIG. 4 illustrates the operation sequence of the ATI processor 34 with focusing on one track (i).

The ATI processor 34 determines whether or not an off-track has occurred in the track (i) based on the output of the off-track detecting unit 41 (S100). In a case where the off-track is determined not to have occurred (S100 No), the ATI processor 34 adds a write count calculated this time to the current ATI count value of the track (i) that is registered in the ATI count table 36a. The ATI processor 34 updates the ATI count value of the track (i) that is registered in the ATI count table 36a based on the result of the addition (S110).

On the other hand, in a case where the off-track is determined to have occurred (S100 Yes), the ATI processor 34 acquires a maximum off-track amount w1 (positive value) toward the inner side and a maximum off-track w2 (positive value) toward the outer side based on the off-track amount OFT of the track (i) that is acquired from the off-track detecting unit 41 (S120).

FIG. 5 illustrates a status in which an off-track occurs when data is written into the track (i). When data is written into the track (i), the off-track having a maximum off-track amount w1 occurs on the inner side. A track (i+1) is adjacent to the inner side. In addition, an off-track having a maximum off-track amount w2 occurs on the outer side. A track (i−1) is adjacent to the outer side. Such off-tracks occurring at the time of writing data have adverse effects on the data qualities of adjacent tracks (i+1) and (i−1).

The ATI processor 34, as represented in the following Equation (1), calculates a write count Cw corresponding to the off-track amount w1 by calculating a to the power of w1 by using the maximum off-track amount w1 toward the inner side and the weighting coefficient α. In other words, the ATI processor 34 calculates the write count Cw by using an exponential function having the weighting coefficient α as the base and having the off-track amount w1 as the exponent. The ATI processor 34 adds the calculated write count Cw to the current ATI count value of the track (i+1) that is registered in the ATI count table 36a. The ATI processor 34 updates the ATI count value of the track (i+1) that is registered in the ATI count table 36a based on a result of the addition.

Cw=α̂w1 (1)

The ATI processor 34, as represented in the following Equation (2), calculates a write count Cw corresponding to the off-track amount w2 by calculating a to the power of w2 by using the maximum off-track amount w2 toward the outer side and the weighting coefficient α. The ATI processor 34 adds the calculated write count Cw to the current ATI count value of the track (i−1) that is registered in the ATI count table 36a. The ATI processor 34 updates the ATI count value of the track (i−1) that is registered in the ATI count table 36a based on a result of the addition (S130).

Cw=α̂w2 (2)

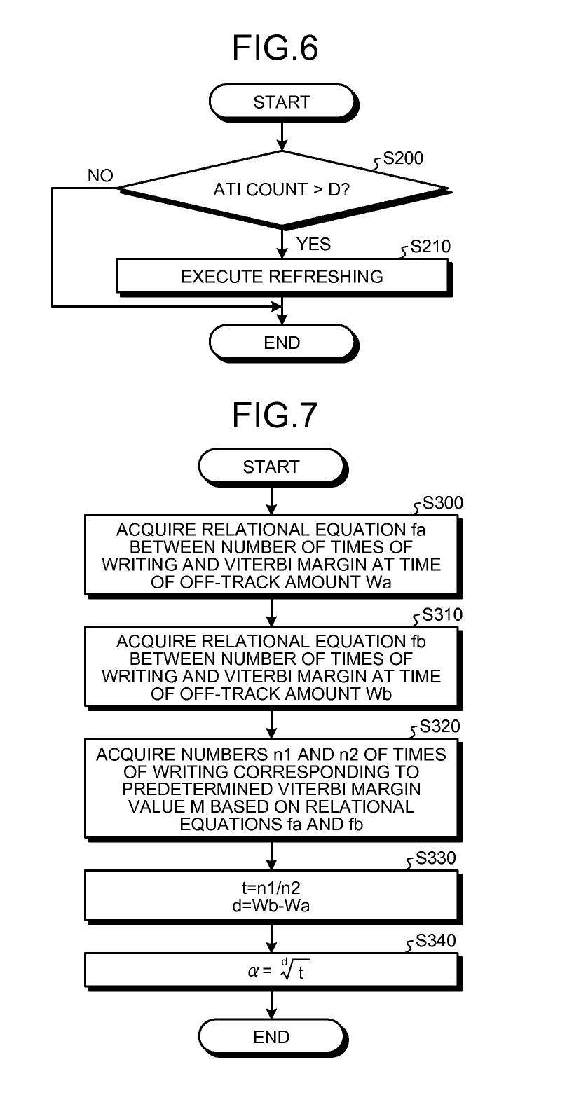

In addition, the ATI processor 34 executes a process illustrated in FIG. 6 for each track. The ATI processor 34 compares the ATI count value of each track that is registered in the ATI count table 36a with a threshold D (S200). As a result of the comparison, for tracks each of which the ATI count value exceeds the threshold D, the ATI processor 34 executes a refresh operation (S210). In the refresh operation, data is read from a track that is a refreshing target, and the read data is rewritten into the same track.

FIG. 7 is a diagram that illustrates an example of the sequence for acquiring the weighting coefficient α. First, a relational equation fa between write quality information of the track (i+1) or the track (i−1) that is an adjacent track and the number of times of writing when the off-track amount of the track (i) is a certain value wa is acquired (S300). As the write quality information, for example, a Viterbi metric margin (hereinafter, referred to as a Viterbi margin), an error rate, or the like is used. The Viterbi margin is a numerical value representing a ratio of the selection of values excluding a value selected as optimal to the value selected as optimal according to a Viterbi detection method. The Viterbi margin is a value directly relating to the error rate. Similarly, a relation equation fb between the write quality information of an adjacent track and the number of times of writing when the off-track amount is a certain value wb (here, wb>wa) is acquired (S310).

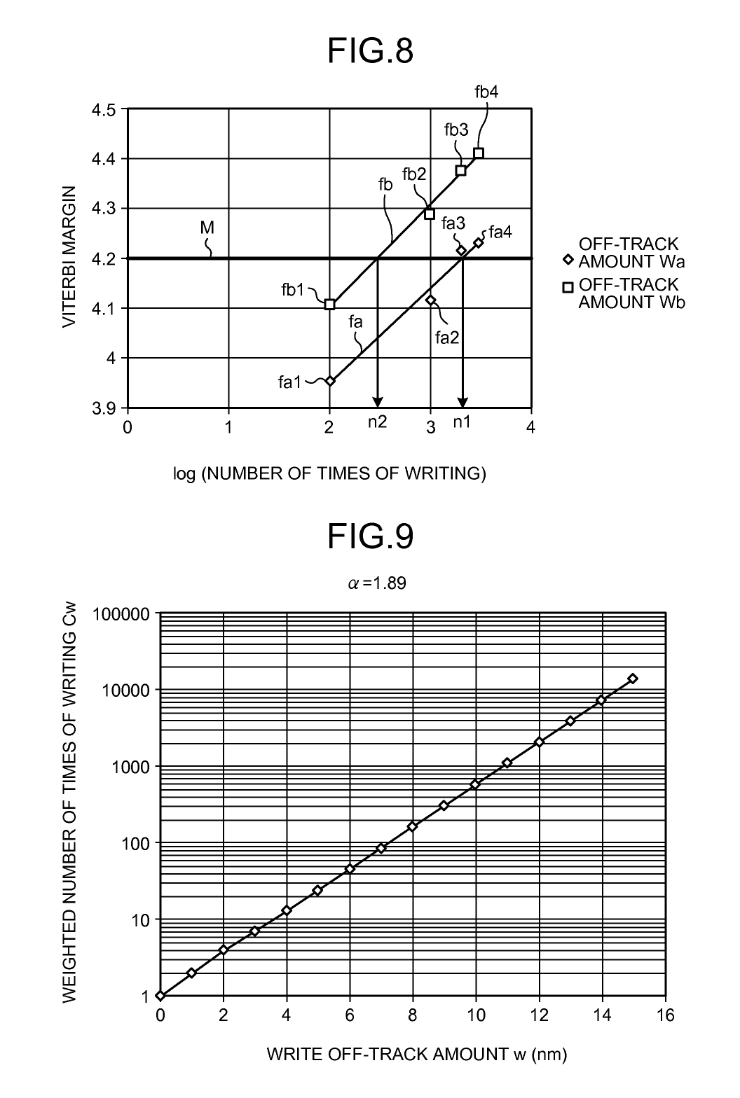

FIG. 8 illustrates the relational equation fa between the Viterbi margin of an adjacent track and the number of times of writing when the off-track amount is wa and the relational equation fb between the Viterbi margin and the number of times of writing of the adjacent track when the off-track amount is wb. Here, the horizontal axis representing the number of times of writing is a logarithmic axis. For example, through an experiment, when the off-track amount is wa, while the number of times of writing is changed to a plurality of mutually-different values, a Viterbi margin corresponding to each of the numbers of times of writing is measured. By acquiring an approximate equation of a plurality of measured values fa1, fa2, fa3, and fa4 acquired in this way, the relational equation fa is acquired. Similarly, by acquiring an approximate equation of a plurality of measured values fb1, fb2, fb3, and fb4, the relational equation fb is acquired.

Referring back to FIG. 7, next, based on the relational equations fa and fb, the numbers n1 and n2 of times of writing corresponding to a predetermined Viterbi margin value M are acquired (S320). The predetermined Viterbi margin value M, as illustrated in FIG. 8, may be an arbitrary value that can intersect both the relational equations fa and fb. Next, a ratio t of n1 to n2 (32 n1/n2) is acquired. In addition, a difference d (=wb−wa) between the off-track amount wa and the off-track amount wb is acquired (S330). Then, the d-th root of t is calculated, whereby the weighting coefficient α is acquired (S340).

For example, in the example illustrated in FIG. 8, when wa=0 nm, wb=3 nm, and M=4.2, n1=10̂3.3=1995 times, and n2=10̂2.47=295 times. The ratio t is 6.76 (1995/295). In addition, d=3 nm. Then, the third root of 6.76=1.89. Accordingly, α=1.89.

FIG. 9 illustrates the relation between the write off-track amount w and the weighted number of times of writing Cw (=α̂w) at the time of α=1.89. In the figure, the vertical axis representing the weighted number of times of writing Cw is a logarithmic axis. Since the weighted number of times of writing Cw is calculated as a to the power of w, the weighted number of times of writing Cw exponentially increases in accordance with the off-track amount w.

As above, in this embodiment, the ATI count value for each track is managed, a weighting factor that exponentially increases in accordance with the off-track amount is calculated, and this weighting factor is added to the weighting factor of an adjacent track. Accordingly, a refresh process that is based on the ATI count value is executed at appropriate timing, and a read error according to the write offset can be prevented.

In this embodiment, while the write count Cw for weighting is calculated based on a maximum value of the write offset amounts, the write count Cw may be calculated by using an average value of the write offset amounts of the track (i).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a magnetic head;
a magnetic disk corresponding to the magnetic head; and
a controller configured to:
manage a first value representing the number of times of writing for each track on the magnetic disk, execute a refresh process for a track having the first value exceeding a first threshold, the refresh process including reading data from the track and rewriting the read data into the track;
detect a first off-track amount during writing for a first track being a writing target track;
calculate a second value exponentially increasing according to the detected first off-track amount; and
add the calculated second value to the first values of tracks adjacent to both sides of the first track.

2. The magnetic disk device according to claim 1, wherein
the controller is configured to calculate the second value based on the detected first off-track amount and a weighting coefficient.

3. The magnetic disk device according to claim 2, wherein the controller is configured to:
specify a second off-track amount being a maximum value of the detected first off-track amounts of the first track; and
calculate the second value by using an exponential function having the weighting coefficient as a base and having the second off-track amount as an exponent.

4. The magnetic disk device according to claim 1, wherein the controller is configured to:
detect a second off-track amount being the off-track amount approaching a second track and a third off-track amount being the off-track amount approaching a third track during the writing for the first track, the second track being adjacent to the first track on an inner side, the third track being adjacent to the first track on an outer side;
calculate a third value and a fourth value, the third value exponentially increasing according to the detected second off-track amount, the fourth value exponentially increasing according to the detected third off-track amount; and
add the calculated third value to the first value of the second track and add the calculated fourth value to the first value of the third track.

5. The magnetic disk device according to claim 4, wherein the controller is configured to:
calculate the third value based on the detected second off-track amount and a weighting coefficient; and
calculate the fourth value based on the detected third off-track amount and the weighting coefficient.

6. The magnetic disk device according to claim 5, wherein the controller is configured to:
specify a fourth off-track amount that is a maximum value of the detected off-track amounts of the second track and specify a fifth off-track amount that is a maximum value of the detected off-track amounts of the third track; and
calculate the third value by using an exponential function having the weighting coefficient as a base and having the fourth off-track amount as an exponent and calculate the fourth value by using an exponential function having the weighting coefficient as a base and having the fifth off-track amount as an exponent.

7. The magnetic disk device according to claim 2, wherein
when a ratio (n1/n2) of the first number n1 of times of writing to the second number n2 of times of writing is t, and a difference between a second off-track amount wa and a third off-track amount wb is d, a value of the weighting coefficient is the d-th root of t, the first number n1 of times of writing being calculated as the number of times of writing for which write quality information is a predetermined value based on a first relation, the second number n2 of times of writing being calculated as the number of times of writing for which the write quality information is the predetermined value based on a second relation, the first relation representing a relation between the number of times of writing at the time of the second off-track amount wa and the write quality information, the second relation representing a relation between the number of times of writing at the time of the third off-track amount wb and the write quality information.

8. The magnetic disk device according to claim 5, wherein
when a ratio (n1/n2) of the first number n1 of times of writing to the second number n2 of times of writing is t, and a difference between a fourth off-track amount wa and a fifth off-track amount wb is d, a value of the weighting coefficient is the d-th root of t, the first number n1 of times of writing being calculated as the number of times of writing for which write quality information is a predetermined value based on a first relation, the second number n2 of times of writing being calculated as the number of times of writing for which the write quality information is the predetermined value based on a second relation, the first relation representing a relation between the number of times of writing at the time of the fourth off-track amount wa and the write quality information, the second relation representing a relation between the number of times of writing at the time of the fifth off-track amount wb and the write quality information.

9. The magnetic disk device according to claim 7, wherein the write quality information is a Viterbi margin.

10. The magnetic disk device according to claim 7, wherein the write quality information is an error rate.

11. A method of controlling a magnetic disk, the method comprising:
managing a first value representing the number of times of writing for each track on the magnetic disk, executing a refresh process for a track having the first value exceeding a first threshold, the refresh process including reading data from the track and rewriting the read data into the track;
detecting a first off-track amount during writing for a first track being a writing target track;
calculating a second value exponentially increasing according to the detected first off-track amount; and
adding the calculated second value to the first values of tracks adjacent to both sides of the first track.

12. The method according to claim 11, further comprising
calculating the second value based on the detected first off-track amount and a weighting coefficient.

13. The method according to claim 12, further comprising:
specifying a second off-track amount being a maximum value of the detected first off-track amounts of the first track; and
calculating the second value by using an exponential function having the weighting coefficient as a base and having the second off-track amount as an exponent.

14. The method according to claim 11, further comprising:
detecting a second off-track amount being the off-track amount approaching a second track and a third off-track amount being the off-track amount approaching a third track during the writing for the first track, the second track being adjacent to the first track on an inner side, the third track being adjacent to the first track on an outer side;
calculating a third value and a fourth value, the third value exponentially increasing according to the detected second off-track amount, the fourth value exponentially increasing according to the detected third off-track amount; and
adding the calculated third value to the first value of the second track and adding the calculated fourth value to the first value of the third track.

15. The method according to claim 14, further comprising:
calculating the third value based on the detected second off-track amount and a weighting coefficient; and
calculating the fourth value based on the detected third off-track amount and the weighting coefficient.

16. The method according to claim 15, further comprising:
specifying a fourth off-track amount that is a maximum value of the detected off-track amounts of the second track and specifying a fifth off-track amount that is a maximum value of the detected off-track amounts of the third track; and
calculating the third value by using an exponential function having the weighting coefficient as a base and having the fourth off-track amount as an exponent and calculating the fourth value by using an exponential function having the weighting coefficient as a base and having the fifth off-track amount as an exponent.

17. The method according to claim 12, further comprising:
acquiring a first relation representing a relation between the number of times of writing at the time of a second off-track amount wa and write quality information and a second relation representing a relation between the number of times of writing at the time of a third off-track amount wb and the write quality information;
acquiring the first number n1 of times of writing that is the number of times of writing for which the write quality information is a predetermined value based on the first relation and acquiring the second number n2 of times of writing that is the number of times of writing for which the write quality information is the predetermined value based on the second relation; and
setting the d-th root of t as the weighting coefficient when a ratio (n1/n2) of the first number n1 of times of writing to the second number n2 of times of writing is t, and a difference between the second off-track amount wa and the third off-track amount wb is d.

18. The method according to claim 15, further comprising:
acquiring a first relation representing a relation between the number of times of writing at the time of a fourth off-track amount wa and write quality information and a second relation representing a relation between the number of times of writing at the time of a fifth off-track amount wb and the write quality information;
acquiring the first number n1 of times of writing that is the number of times of writing for which the write quality information is a predetermined value based on the first relation and acquiring the second number n2 of times of writing that is the number of times of writing for which the write quality information is the predetermined value based on the second relation; and
setting the d-th root of t as the weighting coefficient when a ratio (n1/n2) of the first number n1 of times of writing to the second number n2 of times of writing is t, and a difference between the fourth off-track amount wa and the fifth off-track amount wb is d.

19. The method according to claim 17, wherein the write quality information is configured to be a Viterbi margin.

20. The method according to claim 17, wherein the write quality information is configured to be an error rate.
